(19) United States
(12) Patent Application Publication
(10) Pub. No.: US 2026/0319326 A1
(43) Pub. Date: Oct. 15, 2026

(54) OPTICAL PHASED ARRAY WITH LINEARLY SCALABLE PHASE SHIFTERS FOR 2D BEAM STEERING

(71) Applicant: GlobalFoundries Singapore Pte. Ltd., Singapore (SG)

(72) Inventors: You Sian James TAN, Singapore (SG); Xianshu LUO, Singapore (SG)

(21) Appl. No.: 19/099,367

(22) PCT Filed: Aug. 10, 2022
(86) PCT No.: PCT/SG2022/050569

§ 371 Date: Jan. 28, 2025

(51) Int. Cl. G02F 1/295; G02B 6/12; G02F 1/01; G02F 1/035; G02F 1/313

(52) U.S. Cl. CPC G02F 1/2955; G02B 6/12004; G02F 1/0147; G02F 1/035; G02F 1/3133; G02F 2203/50

(57) ABSTRACT

An optical phased array for 2D steering of an optical beam comprising an optical waveguide, with each waveguide having a plurality of scatterers. A first segment of the optical waveguide is adapted to steer the optical beam in an x-direction, and the first segment comprises a first optical phase shifter. A second segment of the optical waveguide is adapted to steer the optical beam in a different direction than the first segment, and the second segment comprises second optical phase shifter.

### FIELD OF THE INVENTION

This invention relates to beam steering of light, and more particularly to an optical phased array that steer an optical beam in different dimensions and directions using an optical field of a fixed optical wavelength.

### BACKGROUND OF THE INVENTION

Recent advancements in silicon photonics has led to the development of nanophotonic optical phased arrays (OPA). OPA antennas are photonic components that enable altering the direction of the lobe of emitted beam in real time. Such ability to dynamically and precisely shift the emitted beam direction is useful to direct an information signal-carrying beam at a specific target and/or receiver in applications such as light detection and ranging (LiDAR) systems and free-space transceivers.

Beam steering from OPA has traditionally relied on photonic components that incorporate movable mirrors controlled using hydraulic pump and microelectromechanical systems. Further miniaturization efforts resulted in beam steering components that modulate based on material structural properties such as liquid crystal, ferroelectric and phase change materials, or were based on optical properties such as refractive index and optical wavelength.

Of the various beam steering approaches, modulation based on optical properties is particularly suited for on-chip beam steering. This can be achieved using optical phase shifters and tunable optical sources to shift the optical phase difference of the optical field at the beam emitters; respectively by inducing refractive index shift to the optical waveguides in the OPA, and by inducing optical wavelength shift to the optical field sent to the optical waveguides in OPA. To enable two-dimensional (2D) beam steering, it is conventional to use optical phase shifters to steer an optical beam in one dimension, and tunable optical sources to steer the beam in the other dimension. However, the use of an optical wavelength shift for beam steering poses the following problems: i. it is not common to have lasing gain media that allows substantial shifts in optical wavelength, ii. in LiDAR systems, the properties of the object to be detected and the ranging distance can vary with wavelength, iii. in free-space transceivers, the use of optical wavelength for beam steering renders the use of unique optical wavelength for different data streams unfeasible, iv. it can be challenging to find other photonic components in the beam steering system (such as waveguides and photodetectors) that support similarly broad wavelength range as that in the beam steering platform, and v. it can be complex to continuously adjust the optical power of the optical field emitted from the beam steering platform to offset solar irradiance variations of ambient light in free-space at different wavelengths (which the optical field from the platform would have to compete with). Thus, it is important to have a system that enables steering an optical beam in different directions and dimensions using optical field of a fixed optical wavelength.

Although 2D beam steering using purely optical phase shifters can be realised on conventional beam steering platforms for beam steering using a fixed optical wavelength, the number of optical phase shifters typically scales nonlinearly with the number of emitters in the array row. As a result, the following problems arise: i. it can be tedious to manage the beam steering system, ii. the platform would fill up a large footprint from the large number of optical phase shifters required, and iii, the beam steering platform is energy inefficient due to the large number of optical phase shifters.

It would be desirable to provide an improved photonic component that enables steering an optical beam in different directions and dimensions using an optical field of a fixed optical wavelength (coherent light) via optical phase shifters; with the number of optical phase shifters scaling linearly with the number of OPA array rows.

### SUMMARY OF THE INVENTION

In accordance with a first aspect, an optical phased array for 2D steering of an optical beam comprising an optical waveguide, with each waveguide having a plurality of scatterers. A first segment of the optical waveguide is adapted to steer the optical beam in an x-direction, and the first segment comprises a first optical phase shifter(s). A second segment of the optical waveguide is adapted to steer the optical beam in a different direction than the first segment (for example, in a y-direction), and the second segment comprises second optical phase shifter(s).

From the foregoing disclosure and following more detailed description of various embodiments it will be apparent to those skilled in the art that the present invention provides a significant advance in the technology of OPAs. Particularly significant in this regard is the potential the invention affords for providing an OPA with 2D beam steering using optical phase shifters that scale linearly with the number of OPA array rows. Additional features and advantages of various embodiments will be better understood in view of the detailed description provided below.

### BRIEF DESCRIPTION OF THE DRAWINGS

FIG. 1 shows a schematic diagram illustrating the use of optical phase shifters to steer an optical beam in two directions or dimensions (2D) using a fixed optical wavelength, by modulating the optical phases of the optical field in the waveguides along the rows and columns of the OPA in accordance with certain embodiments disclosed herein.

FIG. 2 shows a schematic diagram illustrating the use of optical phase shifters to modulate the optical phases of the optical field in the waveguides along the columns of the OPA in accordance with certain embodiments disclosed herein.

FIG. 3 shows a schematic diagram illustrating the use of optical phase shifters to modulate the optical phases of the optical field in the waveguides along the rows of the OPA in accordance with certain embodiments disclosed herein.

FIG. 4 shows a schematic diagram illustrating the use of optical phase shifters to modulate the optical phases of the optical field in the waveguides along the rows of the OPA in accordance with certain embodiments disclosed herein, at a last column.

FIG. 5 shows a schematic diagram illustrating the use of optical phase shifters to modulate the optical phases of the optical field φₘₙ scattered out-of-plane by scatterers positioned at the columns n of the OPA, which in turn modulates the directionality of scattered optical beam θₓ in the x-axis on a row m, in accordance with certain embodiments disclosed herein.

FIG. 6 shows a schematic diagram illustrating the use of optical phase shifters to modulate the optical phases of the optical field φₘ₁ scattered out-of-plane by scatterers positioned at the rows m of the optical phased array, which in turn modulates the directionality of optical beam θ_{y} scattered out-of-plane in the y-axis on column n=1, in accordance with certain embodiments disclosed herein.

FIG. 7 is a table showing schematic diagrams that illustrate the use of metal thermo-optic optical phase shifters to steer optical beam in both x- and y-dimensions, in accordance with certain embodiments disclosed herein.

FIG. 8 is a table showing schematic diagrams that illustrate the use of optical phase shifters in the form of highly-doped semiconductor thermo-optic heaters to steer optical beam in the x-dimension, and pn-junction plasma-dispersion effect-based modulators to steer the optical beam in y-dimension, both using fixed optical wavelength, in accordance with certain embodiments disclosed herein.

FIG. 9 is a table showing a partial isometric schematic view of optical phase shifters (pn-junction plasma-dispersion effect-based phase shifter, highly-doped semiconductor thermo-optic phase shifter, and metal thermo-optic phase shifters in the four examples of the model of FIG. 9), in accordance with several preferred embodiments disclosed herein.

FIG. 10 shows an example doping effect simulation plot of a resulting phase shift Δ_{φ} and attenuation with respect to an electrical voltage applied to a 6 mm-long pn-doped optical phase shifter according to one embodiment of the OPA disclosed herein.

FIG. 11 is a table showing an estimated resulting z-component of an electric field in accordance with several embodiments of the photonic components disclosed herein at different refractive indices of the waveguide that forms part of the OPA, which can be modulated using phase shifters positioned on or otherwise integrated to the waveguides on the OPA.

FIG. 12 is a table comparing polar plots of resulting far field intensities at different optical phase differences of an optical field sent to the waveguides Δφ_{y} (that is, phase difference Δ_{φ} in the y-dimension), which can be modulated using phase shifters positioned on or otherwise integrated to the waveguides to the OPA.

It should be understood that the appended drawings are not necessarily to scale, presenting a somewhat simplified representation of various features illustrative of the basic principles of the invention. The specific design features of the OPA as disclosed here, including, for example, the specific dimensions of the scatterers/emitters, will be determined in part by the particular intended application and use environment. Certain features of the illustrated embodiments have been enlarged or distorted relative to others to help provide clear understanding. In particular, thin features may be thickened, for example, for clarity of illustration. All references to dimension, direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the optical phased arrays disclosed here. The following detailed discussion of various alternate features and embodiments will illustrate the general principles of the invention with reference to an optical phase assembly for 2D beam steering using phase shifters that scale linearly with a number of optical phase array rows. This is in contrast to conventional OPA for 2D beam steering operated using a fixed optical wavelength which uses optical phase shifters that scale nonlinearly with the number of OPA array rows. The OPA disclosed herein may be used as a beam steering system that can be part of LiDAR systems or free-space transceivers, for example; and can be used as both a transmitter and a receiver. Other embodiments suitable for other applications will be apparent to those skilled in the art given the benefit of this disclosure.

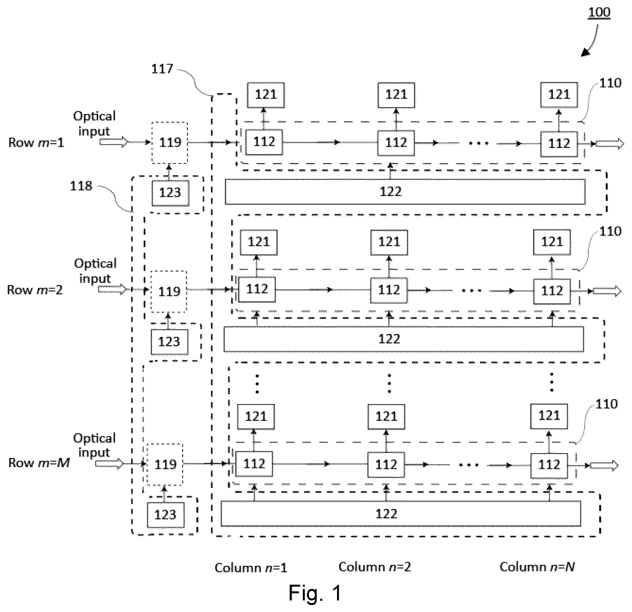

FIG. 1 shows a schematic diagram of an optical phased array (OPA) 100 illustrating the use of optical phase shifters to realise 2D beam steering using an optical field of a fixed optical wavelength, by modulating the optical phases of the optical field in a series of one or more waveguides along the rows (M) and columns (N) of the OPA in accordance with certain embodiments disclosed herein. The OPA comprises an array of operatively connected photonic components formed in rows and columns, having a first segment of optical phase shifters 117 positioned generally adjacent to (below, above, to one side or the other of) or otherwise integrated to (or embedded in) waveguides 100 and scatterers 121 (which can comprise a series of rows and columns of the array) and a second segment of optical phase shifters 118 positioned adjacent to or otherwise integrated to waveguides 119 (which can comprise another series of rows and columns of the array) operatively connected to the first segment. The first segment enables steering optical beam in the x-dimension, and comprises at least one first optical phase shifter 122 (that forms the array 117) positioned generally adjacent to or otherwise integrated to at least one (M≥1) waveguide 110 and a plurality (N) 120 of optical nanostructures (also referred to as scatterers or emitters) 121 positioned along each waveguide at the periodic points 112 in the segment. The second segment enables steering optical beam in a different dimension than the x-dimension, typically a y-dimension (i.e., at 90° azimuthally from the x-dimension), and comprises at least one second optical phase shifter 123 (that forms the array 118) positioned adjacent to or otherwise integrated to at least one waveguide 119 that is operatively connected to the waveguides 110 in the first segment. Each phase shifter 122 which forms part of the array 117 modulates the optical phases of the optical field in the optical waveguide 110, while each phase shifter 123 which forms part of the array 118 modulates the optical phases of the optical field of the optical waveguide 119 connected to optical waveguide 110. The OPA can be scaled up to have any number MxN of optical waveguides and scatterers. Each m of the M optical waveguides 119 is configured to receive an optical field that propagates to m of the M optical waveguides 110. The subscripts m and n respectively denote the array row and column. In a preferred embodiment, each column can comprise the same type of optical phase shifter, and there can be only one column of optical phase shifters in the second segment. Optionally each the optical phase shifters can be formed as a different layer (with a first layer for the first optical phase shifters and a second layer for the second optical phase shifters, wherein the first layer is adjacent to each of the corresponding waveguides, and the second layer is adjacent to each of the corresponding waveguides). Also, the first optical phase shifters may comprise a different material than the second optical phase shifters. Both the first optical phase shifters and second optical phase shifters may be located adjacent to or integrated to the corresponding waveguides.

Advantageously, such photonic components in the OPA can be implemented fully on-chip using standard fabrication techniques, such as lithography and deposition, and standard photonic materials including but are not limited to silicon (Si), silicon nitride (Si₃N₄), germanium (Ge), lithium niobate (Li₃NbO₃), barium titanite (BaTiO₃) and indium phosphide (InP), for example. Optionally the wavelength of the input optical field can be in the short wavelength infrared region of the electromagnetic spectrum at 1.4 μm to 1.7 μm, for example. Visible wavelengths (0.38 μm to 0.75 μm), and near-infrared wavelengths (0.75 μm to 1.4 μm) may also be used, depending upon the application of the photonic component. One or more electrical connections may be provided between the first optical phase shifters in the first segments and the second optical phase shifters in the second segments. Further, in LiDAR systems, a controller can be adapted to work with the arrays (117 and 118) of optical phase shifters (122 and 123) positioned adjacent to or otherwise integrated to at least one waveguide (110 and 119) and the scatterers 121 and receive an emitted optical field reflected from an object, and incorporate a processor to calculate the information about the surface characteristics of the object based on the reflected light received by the scatterers and the waveguide.

The waveguide (110 and 119) may be circular or may be a rectangular (rib or ridge) waveguide having an elongate top surface and side walls extending from the top surface. A refractive index of the waveguide core can be larger than that of the surrounding waveguide cladding. The waveguide cladding can comprise undercladding and overcladding. The waveguide can comprise any of several different types of waveguides. For example, the waveguide can be a total internal reflection-based waveguide (which makes up the overwhelming majority of optical waveguides traditionally used in integrated photonics), a slot waveguide, and surface plasmon polariton waveguide. Alternatively, an in-plane scattering waveguide may be used, such as waveguide formed from photonic crystals (which also use total internal reflection) and metamaterials. A composition of each of the plurality of waveguides can be, for example, at least one of Si, SiO₂, BaTiO₃, Li₃NbO₃, InP, a III-V compound, a II-VI compound, and a polymer, for example. Each of the plurality of waveguides may be doped with a p-type or an n-type material. The waveguide can support any of the optical waveguide modes, for example, Transverse Electric mode and Transverse Magnetic mode. The scatterers/emitters 121 can be either Mie scatterers or Rayleigh scatterers. More particularly, Mie scattering refers primarily to scattering of optical field from scatterers whose diameter, width or diagonal is usually close to a wavelength of the incident optical field, whereas in Rayleigh scattering, the diameter, width or diagonal of the scatterers is at most one-tenth of the wavelength of the incident optical field. A composition of each of the plurality of scatterers can be, for example, at least one of Si, SiO₂, BaTiO₃, Li₃NbO₃, InP, a III-V compound, a II-VI compound, and a polymer, for example. Each of the plurality of scatterers may be also doped with a positively-charged dopant (p-type material) or a negatively-charged dopant (n-type material). Types of positively-charged dopants comprise, for example, boron, gallium, and aluminium; while types of negatively-charged dopants comprise, for example, arsenic, phosphorus, and antimony. Each of the plurality of the scatterers can be embedded in the corresponding waveguide, and/or each of the plurality of scatterers may be in contact with a top wall or a side wall of the corresponding waveguide.

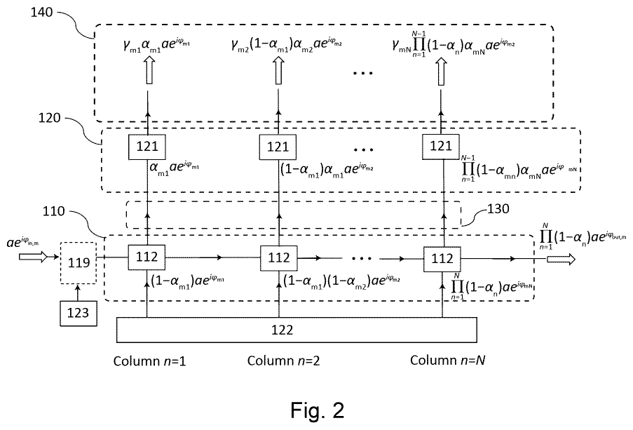

FIG. 2 shows a schematic diagram of columns (N) of the OPA on row m, according to an embodiment of the invention. Each row comprises optical phase shifter 122 to shift the optical phase of the optical field in the waveguide 110 perturbed by a plurality 120 of scatterers 121. The waveguide 110 is operatively connected to waveguide 119 on/to which optical phase shifters 122 (that forms the array 117) are positioned/otherwise integrated. The scatterers are placed at the periodic points 112 generally adjacent to the waveguides 110. Each scatterer 121 causes a portion of optical field from the waveguide (with a and φ_{in,m} respectively denoting the amplitude and phase of the optical field) to be evanescently coupled 130 (by the factor α) and scattered out-of-plane 140 (by the factor γ). Each m of the M optical waveguides 119 is configured to receive an optical field of wavelength λₒ that can be represented using the plane wave approximation ae^{iφ}_{in,m}, with a and φ_{in,m} respectively denoting the amplitude and phase of the optical field sent to each of the waveguides. The subscripts m and n respectively, again denote the array row and column.

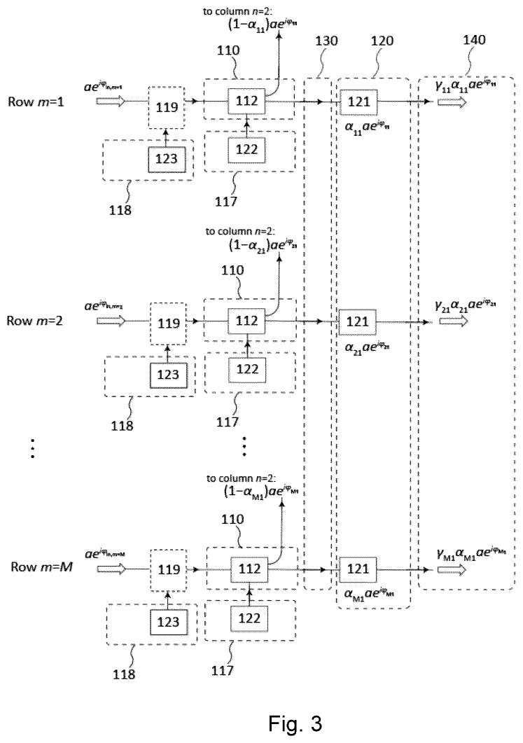

FIG. 3 shows a schematic diagram similar to FIG. 2, but showing the rows of the OPA on the first (n=1) column, according to an embodiment of the invention. Each column comprises an array 118 of optical phase shifters 123 to shift the optical phases of the optical field in the waveguides 119 connected to waveguides 110 that is perturbed by a plurality 120 of scatterers 121. Each scatterer 121 causes a portion of the optical field from the waveguide (with a and φ_{in,m} respectively denoting the amplitude and phase of the optical field) to be evanescently coupled 130 (by the factor α) and be scattered out-of-plane 140 (by the factor γ). The subscripts m and n respectively, again denote the array row and column.

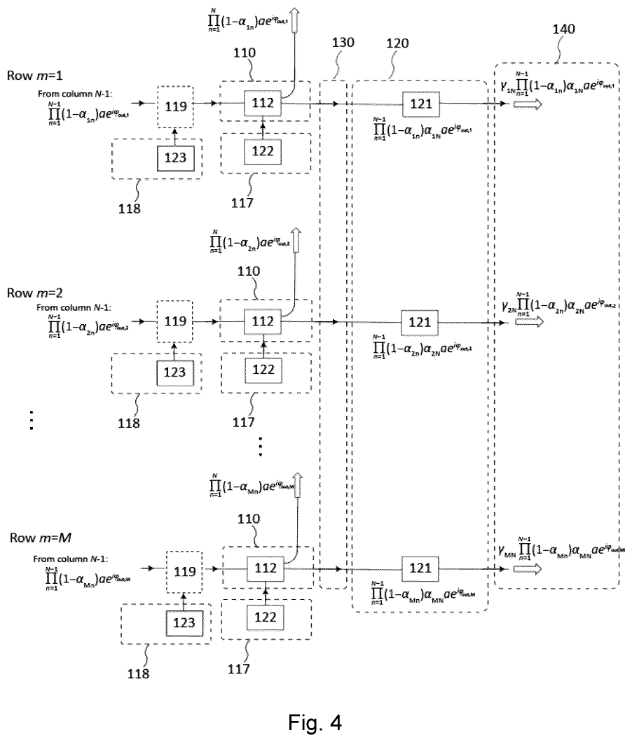

FIG. 4 shows a schematic diagram similar to FIG. 3, but showing the rows of the OPA on the last (n=N) column. Each column comprises an array 118 of optical phase shifters 123 to shift the optical phases of the optical field in the waveguides 119 connected to waveguides 110 that is perturbed by a plurality 120 of scatterers 121, and also resulting a portion of optical field from the waveguides 110 (with a and φ_{in,m} respectively denoting the amplitude and phase of the optical field) to be evanescently coupled 130 (by the factor α) and be scattered out-of-plane 140 (by the factor γ) by the scatterers 121, according to one embodiment. The subscripts m and n respectively, again denote the array row and column.

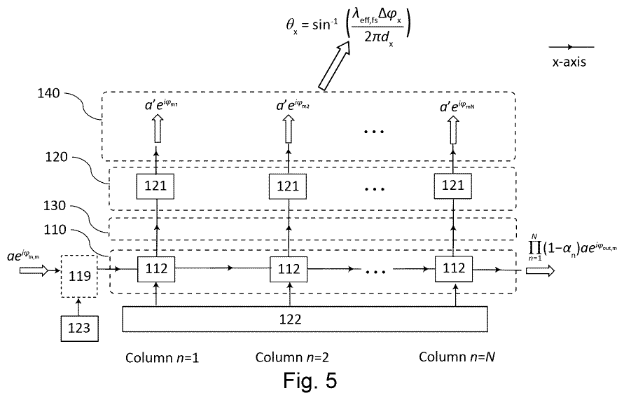

FIG. 5 summarizes the beam steering function of the first segment, and shows a schematic diagram illustrating the use of optical phase shifters to modulate the directionality of scattered optical beam in the x-axis θₓ on row m by shifting via optical phase shifter 122 the optical phases of the optical field in the waveguide 110 (with a and φ_{in,m} respectively denoting the amplitude and phase of the optical field) to be evanescently coupled 130 (by the factor α) and be scattered out-of-plane 140 (by the factor γ) by the scatterers 121 positioned at the columns n of the OPA, according to one embodiment. The subscripts m and n respectively denote the array row and column. λ_{eff,fs}, Δφₓ, and dₓ are respectively the effective wavelength of the optical field in free-space, the optical phase difference of the optical field at the scatterers (in the x-direction), and scatterer pitch (in the x-direction). a′ is the approximated amplitude of the optical field scattered out-of plane from each scatterer.

Beam directionality (or beam steering angle) θ of the OPA—which is a function of emitter pitch d, the distance 124 between centers of neighbouring scatterers which act as emitters—can be designed based on the following equation:

$$θ = {sin}^{- 1} ( \frac{{λ}_{eff , fs}}{2 d} \frac{Δ ϕ}{π} ) \qquad ( 1 )$$

where
λ_{eff,fs}=λₒ/n_{eff,fs}, is the effective wavelength of optical field in free-space,
λₒ is the wavelength of the optical field,
n_{eff,fs} is the effective refractive index of the medium in free space, and
Δ_{φ} is the optical phase difference of the optical field at the emitters/scatterers 121.

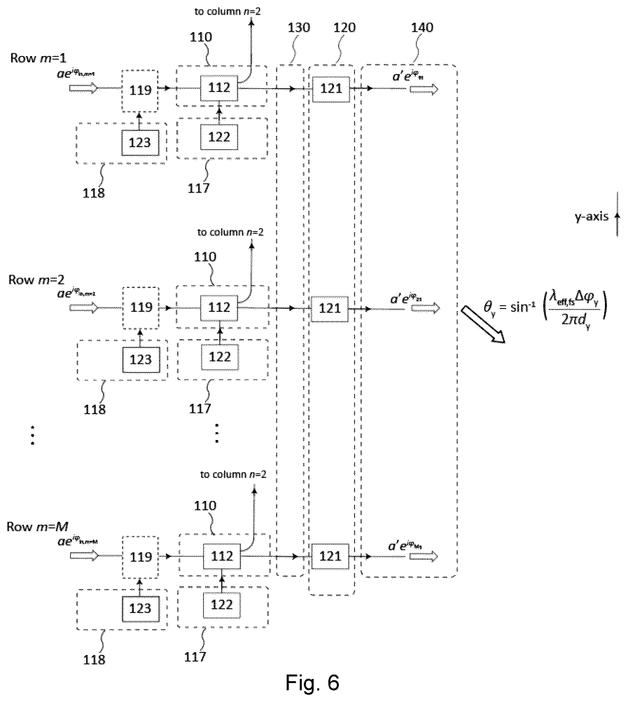

FIG. 6 summarizes the beam steering function of the second segment, and shows a schematic diagram similar to FIG. 5, but showing the use of optical phase shifters to modulate the directionality of scattered optical beam in the y-axis Oy on column n=1 by shifting via the array 118 of optical phase shifters 123 the optical phases of the optical field in the waveguides 119 (with a and φ_{in,m} respectively denoting the amplitude and phase of the optical field) connected to waveguides 110 to be evanescently coupled 130 and be scattered out-of-plane 140 by scatterers 121 positioned at the columns n of the OPA, according to one embodiment. The subscripts m and n respectively denote the array row and column. λ_{eff,fs}, Δφ_{y}, and d_{y} are respectively the effective wavelength of an optical field in free-space, the optical phase difference of the optical field at the scatterers (in the y-direction), and scatterer pitch (in the y-direction). a′ is the approximated amplitude of the optical field scattered out-of-plane from each scatterer.

The optical phases of the optical field in the waveguides 110 in first segment 117 and second segment 118, which respectively determine the beam directionality in the x- and y-direction/dimension, can be varied by changing the refractive index of the waveguides in the arrays. Both the first optical phase shifters and the second optical phase shifters can comprise either a phase shifter based on thermo-optic effect, plasma dispersion effect, electro-optic effect (such as Pockel's effect), microelectromechanically adjusted evanescent field perturbations (which changes the effective refractive index of OPA waveguides), or material structural change (such as liquid crystal, ferroelectric, and phase change materials). The thermo-optic phase shifter can comprises a metal heater, an alloy heater, a ceramic heater, and a highly doped semiconductor heater; the plasma-dispersion effect-based doped phase shifter can comprise a pn-doped or a pin-doped semiconductor; the electro-optic effect-based phase shifter can comprise a Pockel's effect-based modulator such as Li₃NbO₃ and BaTiO₃, or a Kerr's effect-based modulator; the photonic microelectromechanical system switching phase shifter can comprise a microelectromechanical system switch that introduces variations in evanescent field perturbations to change the effective refractive index of the optical phased array waveguides; and the material structural change-based phase shifter can comprise a liquid crystal, a ferroelectric, or a phase change material. The phase shifters, which modify the refractive index of the waveguides in the OPA—may be the same as each other, or different, and the first phase shifters may be the same or different than the second phase shifters, as needed for the particular intended function. The change in the refractive index can advantageously be induced by, for example electrically heating the waveguide (via thermo-optic effect), electrically changing the spatial carrier concentration (via plasma dispersion effect to modify a refractive index and adsorption of the phase shifter) in a doped semiconductor waveguide and electrically changing the birefringence of the waveguide (via electro-optic effect). Heat, spatial carrier concentration change, and optical birefringence change in waveguides may be introduced by applying voltage respectively to the thermo-optic phase shifter (which can be a metal, ceramic/alloy such as indium tin oxide, or heavily doped semiconductor heater near the waveguides, by use of a doped/ion implanted semiconductor region that extends along the waveguide (hereafter, a doped semiconductor phase shifter)), and by applying voltage to electro-optic phase shifter (which is formed using material with high electro-optic coefficient, for example that which exhibit Pockel's effect). The metal heater may be constructed using materials with high thermo-optical coefficient, including but not limited to titanium nitride (TiN), nickel-chromium (NiCr), and the doped semiconductor heater may include semiconductor material heavily doped with positively charged (p++) or negatively charged (n++) dopant. The doping concentration of the heavily doped heater region may be Nₐ~10²⁰ cm⁻³ for n++ heater, and N_{d}~10²⁰ cm⁻³ for p++ heater. Alternatively, a phase shifter based on plasma dispersion effect can comprise either a pn-doped or a pin-doped semiconductor. The doping concentration of the plasma dispersion effect-based doped semiconductor region may be Nₐ~10¹⁷ to 10¹⁸ cm⁻³ for the n-doped region, and N_{d}~10¹⁷ to 10¹⁸ cm⁻³ for the p-doped region. The doping on waveguides to enable spatial carrier concentration change in waveguides may be formed using a pn-junction or a pin-junction. A pn-junction is a junction having a region with positively charged dopant implanted to the waveguide (p-doped region) adjacent to a region with negatively-charged dopant implanted to the waveguide (n-doped region), while a pin-junction is a junction having a p-doped region adjacent to an non-doped region (or ‘intrinsic’ region) adjacent to an n-doped region. Phase shifter based on electro-optic effect may be constructed using material with high electro-optic coefficient, for example Li₃NbO₃ and BaTiO₃.

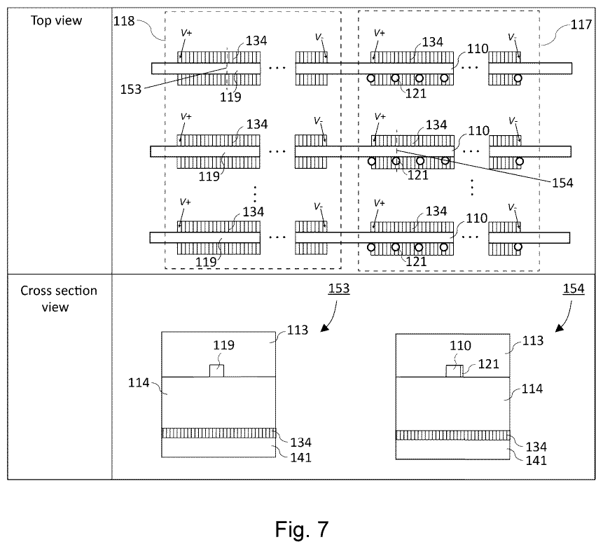

FIG. 7 is a table showing a schematic top view of one embodiment of an OPA 110 which corresponds to that in FIG. 1, having a photonic component 117 to steer optical beam in the x-direction (due to optical phase shifts applied to the waveguides in the first segment) and 118 to steer optical beam in the y-direction (due to optical phase shifts applied to the waveguides 119 in the second segment). The photonic component 117 is shown with an embodiment of thermo-optic phase shifter 154 (an example of optical phase shifters 122) comprising titanium nitride (TiN) thermo-optical heaters 134 (on substrate 141) to modulate the optical phases of the optical field in the waveguides 110 perturbed by a plurality of scatterers 121 positioned along the waveguides. The waveguide cladding can comprise undercladding 114 and overcladding 113. The heater heats the waveguides in first segment, and thereby modulates the refractive index of the waveguides in the first segment to shift the optical phase difference of the optical field between the beam emitters in the x-direction, which in turn steers the optical beam along the x-direction. The photonic component 118 is shown with an embodiment of thermo-optic phase shifter 153 (an example of optical phase shifters 123) also comprising titanium nitride (TIN) thermo-optical heaters 134 (on substrate 141) to modulate the optical phases of the optical field in the first segment waveguides connected to second segment waveguides 110. The heater heats the waveguides in second segment, and thereby modulates the refractive index of the waveguides in the second segment to shift the optical phase difference of the optical field between the beam emitters in the y-direction, which in turn steers the optical beam along the y-direction. Each thermo-optical heaters 134 may be connected to a metal structure (on the bottom layer), electrically connected to another metal structure (on the top layer) through an electrical via. Advantageously, the heating of thermo-optical heaters can be introduced by applying voltage to electrical pads electrically connected to metal structure.

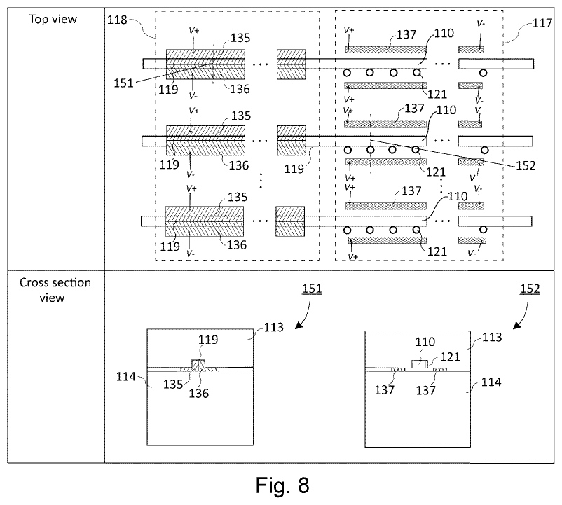

FIG. 8 is a table showing a schematic top view of another embodiment of an OPA which also corresponds to that in FIG. 1, again having a photonic component 117 to steer optical beam in the x-direction (due to optical phase shifts applied to the waveguides 110 in the first segment) and 118 to steer optical beam in the y-direction (due to optical phase shifts applied to the waveguides 119 in the second segment) in accordance with one embodiment. The photonic component 117 is shown with optical phase shifters 122 comprising n++ (heavily doped, for example with acceptor concentration Nₐ=1×10²⁰ cm³) doped (ion implanted) thermo-optical heaters 137 to modulate the optical phases of the optical field in the waveguides 110 perturbed by a plurality of scatterers 121 positioned along the waveguides. The waveguide cladding can comprise undercladding 114 and overcladding 113. The heater heats the waveguides 110 in first segment, and thereby modulates the refractive index of the waveguides 110 in the first segment to shift the optical phase difference of the optical field between the beam emitters in the x-direction, which in turn steers the optical beam along the x-direction. The photonic component 118 is shown with optical phase shifters 123 comprising pn-junction (p doped region labelled 135, and n-doped region labelled 136) on the waveguides 119, to modulate the optical phases of the optical field in the waveguides 119. Voltage applied across the pn-junctions which forms the optical phase shifter 122 introduces plasma dispersion effect in the waveguides 119 in the second segment, and thereby modulates the refractive index of the waveguides 119 to shift the optical phase difference of the optical field between the beam emitters in the y-direction, which in turn steers the optical beam along the y-direction. The doped semiconductor structures 135, 136 and 137 may be connected to a metal structure (on the bottom layer), electrically connected to another metal structure (on the top layer) through an electrical via. Advantageously, plasma dispersion effect can be introduced from the doped semiconductor waveguide structures 135 and 136 by applying voltage to electrical pads electrically connected to metal structure. Likewise, the heating of thermo-optical heaters can be introduced from the heavily doped semiconductor structure 137 by applying voltage to electrical pads electrically connected to metal structure.

The phase shifters 122 need not extend along an entire length of the waveguides 110 in the first segment, and the phase shifters 123 need not extend along an entire length of the waveguides 119 in the second segment. The desired optical phase shift may be modified by varying the portion of the segments to which the phase shifter extends, creating an optical phase shifted region of each segment.

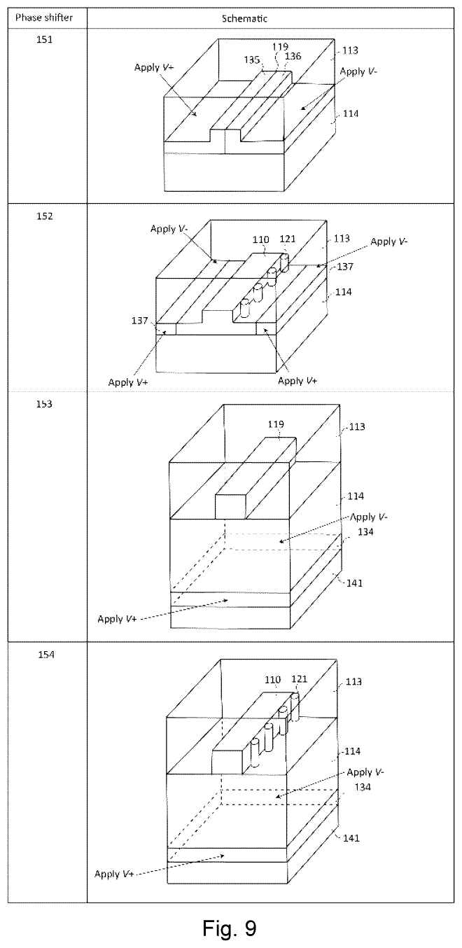

FIG. 9 is a table showing a partial isometric schematic view of different optical phase shifters (a highly doped semiconductor thermo-optic phase shifter 152 in the first segment, a pn-doped semiconductor phase shifter 151 in the second segment, metal thermo-optic phase shifters in the first and second segments (154 and 153 respectively), in the four examples of the model of FIG. 9, that correspond to the optical phase shifters represented in FIG. 7 and FIG. 8) in accordance with several preferred embodiments of optical phase shifters. For example, in accordance with one embodiment of OPA, the OPA 100 can comprise rows (M) of metal thermo-optic optical phase shifters 154 positioned adjacent to or otherwise integrated to total internal reflection-based waveguides 119 formed from Si₃N₄ at a first segment, and separate rows (M) of metal thermo-optic optical phase shifters 153 positioned adjacent to or otherwise integrated to total internal reflection-based waveguides 110 and scatterers 121 formed from Si₃N₄ at a second segment. In accordance with another embodiment of the OPA, the OPA 100 can comprise first rows (M) of pn-doped optical phase shifters 152 at a first segment, and separate second rows (M) of doped semiconductor thermo-optic optical phase shifters 151 at a second segment. Optionally, the number of rows (M) and column (N) of the OPA 100 can range between 2 to 10000, for example. The OPA 100 that comprise optical phase shifters (117 and 118), which can in turn comprise any of several different types of optical phase shifters (metal thermo-optic optical phase shifters, pn-doped optical phase shifters, pin-doped optical phase shifters, doped semiconductor thermo-optic optical phase shifters, optical phase shifters based on thermo-optic effect) adapted for use in LiDAR systems, or free-space transceivers, for example.

The optical phase shift induced by optical phase shifters for beam steering differs depending on design parameters. For thermo-optic phase shifters, the optical phase shift depends on the temperature coefficient of the waveguide material dnldT, and the length of the heated waveguide region L. The induced optical phase shift can be conveniently described as a function of waveguide temperature increase ΔT and effective wavelength of the optical field in the waveguide λ_{eff,wg}:

$${Δϕ}^{′} = \frac{2 π L Δ T}{{λ}_{eff . wg}} ( \frac{dn}{dT} ) \qquad ( 2 )$$

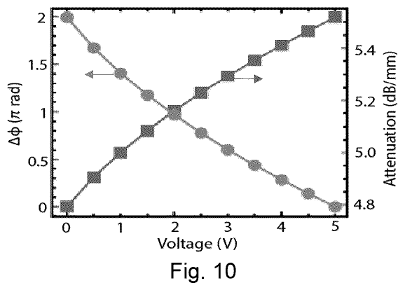

For example, to induce a 2π phase shift using ΔT=50 K (or 50° C.), with the parameters dn/dT=3.3×10⁻⁴ K⁻¹ and λ_{eff,wg}≈1 μm, the estimated length of the thermo-optic phase shifter is L≈60 μm. For plasma dispersion effect based doped semiconductor optical phase shifters, the optical phase shift depends on the doping concentration on the waveguide which forms the phase shifter. FIG. 10 shows an example doping effect simulation plot of a phase shift Δφ and attenuation with respect to an electrical voltage applied to a 6 mm-long pn-doped optical phase shifter according to one embodiment of the OPA disclosed herein, obtained using Silvaco simulation software tool. In the simulation example, the acceptor Nₐ and donor N_{d} doping concentration are Nₐ=N_{d}=3×10¹⁸ cm³ on 0.22 μm height optical waveguide partially etched with a 90 nm slab height. The simulation results indicate an optical phase modulation efficiency of 1.494 V·cm can advantageously be achieved from the designed structure.

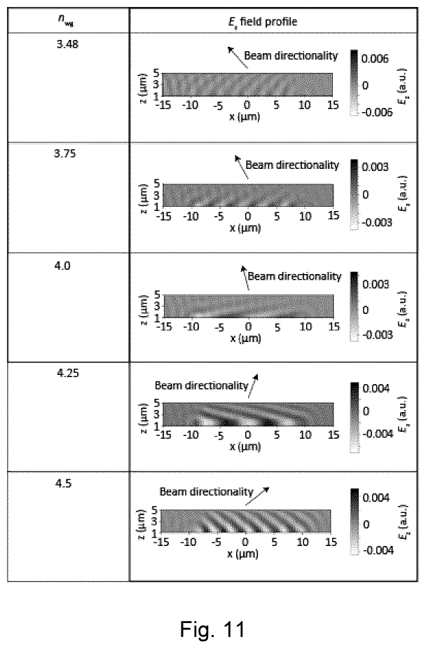

FIG. 11 is a table showing finite-difference time-domain (FDTD) numerically simulated resulting z-component of the electric field (E_{z}) profiles of embodiments of the photonic components at d=0.78 μm along an xz-cross section disclosed at different waveguide refractive index n_{wg} (3.48, 3.75, 4.0, 4.25 and 4.5 in the five examples of the model of FIG. 11). From Equation 1, in particular for θ in the x-direction (or θₓ; direction specified in the subscript), it can be determined that when Δφ=0, that is, when d=λ_{eff,wg} where λ_{eff,wg}=λₒ/n_{eff,wg} is the effective wavelength of the optical field in the waveguide (in our case λ_{eff,wg}=0.78 μm) and n_{eff,wg} is the effective refractive index of the waveguide medium, the scattered (or emitted) optical field propagates in free space in a direction exactly perpendicular to the waveguide structure. Changing λ_{eff,wg}/d and/or Δφ shifts the beam directionality from a vertically perpendicular direction (in the z-axis). For example, in accordance with one embodiment using 1.55 μm wavelength as the optical field, the scatterer is formed from Si can have a diameter of about 160 nm, the waveguide supports Transverse Magnetic optical waveguide mode with 0.7 μm width and 0.22 μm side wall thickness or height, partially etched with a 90 nm slab height along with air overcladding and SiO₂ undercladding. Advantageously in one embodiment, one optical phase shifter 122 can be positioned on or otherwise integrated to each waveguide 110 perturbed by a plurality of emitters/scatterers 121 to enable simultaneous optical phase shift to the entire row of scatterers for beam steering in the x-direction.

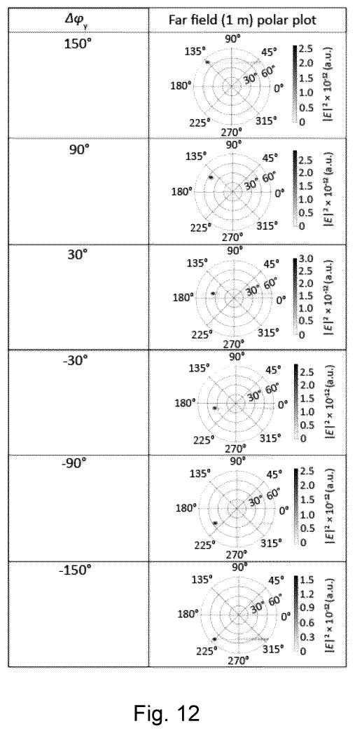

FIG. 12 is a table comparing polar plots of resulting far field intensities with respect to an azimuth and a zenith viewing angle at different optical phase differences of the input optical field sent to the waveguides Δφ_{y} (that is, optical phase Ao in the y-direction) which can be modulated using phase shifters positioned on or otherwise integrated to the waveguides to the OPA, disclosed herein at different Δφ_{y} (150°, 90° 30°, −30°, −90°, −150° in the six examples in the model of FIG. 12). In accordance with one embodiment using 1.55 μm wavelength as the optical field, each row of waveguides are separated by 0.9 μm, with the scatterer formed from Si having a diameter of about 160 nm, the waveguide supports Transverse Magnetic optical waveguide mode with 0.7 μm width and 0.22 μm side wall thickness or height, partially etched with a 90 nm slab height along with air overcladding and SiO₂ undercladding. In one embodiment, one optical phase shifter 123 can be positioned on or otherwise integrated to each waveguide that is connected to the waveguides 110 for beam steering in the y-direction. Advantageously, when this configuration is combined with a separate configuration of using one other optical phase shifter 122 positioned on or otherwise integrated to each waveguide 110 perturbed by a plurality of emitters/scatterers 121 for beam steering in the x-direction, the total number of optical phase shifters for 2D beam steering scales linearly (that is, the total number of optical phase shifters is linearly proportional to the number of OPA array rows. For example, if there are 5 rows in the optical phase array, a total number of phase shifters can be 2×5=10 phase shifters (as a minimum number of phase shifters). There can also be 3×5=15 phase shifters, or 4×5=20 phase shifters, and so on.

From the foregoing disclosure and detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An optical phased array for 2D steering of an optical beam comprising, in combination:
at least one optical waveguide having a refractive index, with each waveguide having a plurality of scatterers;
a first segment at the at least one optical waveguide, wherein the first segment is adapted to steer the optical beam in an x-direction, and the first segment comprises at least one first optical phase shifter positioned below or above the at least one optical waveguide and the scatterers; and
a second segment at the at least one optical waveguide, wherein the second segment is adapted to steer the optical beam in a different direction than the first segment, and the second segment comprises at least one second optical phase shifter positioned below or above the at least one optical waveguide.

2. The optical phased array of claim 1 wherein the at least one first optical phase shifter is different from the at least one second optical phase shifter.

3. The optical phased array of claim 1 further comprising at least one electrical connection between the at least one first optical phase shifter in the first segment and the at least one second optical phase shifter in the second segment.

4. The optical phased array of claim 1 wherein each of the at least one first optical phase shifter and the at least one second optical phase shifter changes the refractive index of the waveguide based on one of a thermo-optic effect, a plasma dispersion effect, an electro-optic effect, a photonic microelectromechanical system switching, or a material structural change.

5. The optical phased array of claim 4 wherein the thermo-optic phase shifter comprises one of a metal heater, an alloy heater, a ceramic heater, and a highly doped semiconductor heater;
the plasma-dispersion effect-based doped phase shifter comprises one of a pn-doped and a pin-doped semiconductor;
the electro-optic effect-based comprises one of a Pockel's effect-based modulator and a Kerr's effect-based modulator;
the photonic microelectromechanical system switching comprises one of a microelectromechanical system switch that introduces variations in evanescent field perturbations to change the refractive index of the waveguides; and
the material structural change comprises one of a liquid crystal, a ferroelectric, and a phase change material.

6. The optical phased array of claim 1 comprising a first row of first segments and a second row of second segments, wherein the at least one first optical phase shifters in each first segment are operatively connected to the at least one second optical phase shifters in the second segment.

7. The optical phased array of claim 1 wherein
the at least one waveguide comprises a plurality of waveguides, the at least one first optical phase shifter comprises a plurality of first optical phase shifters, and the at least one second optical phase shifter comprises a plurality of second optical phase shifters; and
each first optical phase shifter comprises a first layer positioned below or above each of the corresponding waveguides, and each second optical phase shifter comprises a second layer positioned below or above each of the corresponding waveguides.

8. The optical phased array of claim 1 wherein the at least one waveguide and each of the corresponding scatterers comprises independently at least one or more of Si, SiO₂ Si₃N₄, BaTiO₃, Li₃NbO₃, InP, a polymer, a III-V compound other than InP, and a II-VI compound.

9. The optical phased array of claim 1 wherein the at least one waveguide and each of the corresponding scatterers are independently doped with a p-type or an n-type material.

10. The optical phased array of claim 1 wherein each of the plurality of scatterers comprise one of Mie scatterers and Rayleigh scatterers.

11. The optical phased array of claim 1 wherein each of the plurality of the scatterers are embedded in the corresponding at least one waveguide.

12. The optical phased array of claim 1 wherein each of the plurality of scatterers are in contact with a top wall or a side wall of the corresponding at least one waveguide.

13. The optical phased array of claim 1 wherein each of the at least one waveguide is one of a total internal reflection-based waveguide and an in-plane scattering waveguide.

14. The optical phased array of claim 1 wherein each of the at least one waveguide is a rectangular waveguide having an elongate top surface and side walls extending from the top surface.

15. The optical phased array of claim 1 further comprising a controller adapted to calculate information about an object based on the optical beam.

16. The optical phased array of claim 1 having a number of rows, wherein a number of the optical phase shifters is linearly proportional with number of rows.
